(19) United States
(12) Patent Application Publication
(10) Pub. No.: US 2016/0308314 A1
(43) Pub. Date: Oct. 20, 2016

(54) ELECTRICAL CONNECTOR

(71) Applicant: ALLTOP ELECTRONICS (SUZHOU) LTD., Taicang City (CN)

(72) Inventors: Wang-I YU, JHONGHE City (TW); Yi-Chang CHEN, JHONGHE City (TW); Feng ZHENG, JHONGHE City (TW); Yong-Gang ZHANG, JHONGHE City (TW); Li-Li LIANG, JHONGHE City (TW)

(73) Assignee: ALLTOP ELECTRONICS (SUZHOU) LTD., Taicang City (CN)

(21) Appl. No.: 14/808,543

(22) Filed: Jul. 24, 2015

(30) Foreign Application Priority Data
Apr. 16, 2015 (CN) 201510181591.1

(51) Int. Cl. H01R 24/60

(52) U.S. Cl. CPC H01R 24/60

(57) ABSTRACT

An electrical connector includes an insulative housing, a plurality of contacts and a circuit board. The insulative housing has a body portion and a mating portion forwardly extending from the body portion. The contacts include a plurality of ground contacts and a plurality of pairs of differential signal contacts located between the ground contacts. Each contact has a retaining portion retained in the insulative housing, a contact portion extending to the mating portion from one end of the retaining portion, and a tail portion extending to a rear side of the body portion from another end of the retaining portion. The circuit board is arranged at a rear side of the body portion, and has a plurality of ground connections and a conductive path connecting the ground connections together. The ground connections connect with the tail portions of the ground contacts.

### BACKGROUND

1. Technical Field

The present disclosure relates to an electrical connector, and more particularly to an electrical connector capable of connecting wires conveniently.

2. Description of Related Art

Electrical connectors are widely used on various consumer electronic products for transmitting digital signal, audio signal and image signal etc. The electrical connectors usually include a number of terminals, an insulative housing supporting the terminals and a number of wires connecting with the terminals. Due to continuing trend toward miniaturization and improved electrical performance by electronics industry, requirement for greater contact density and higher electrical speeds are constantly being promulgated. Correspondingly, the wires will be arranged density too, which results in that the connecting operation between the wires and the terminals will be difficult, adjacent wires may be contact with each other and bring short circuited therebetween.

It is desirable to provide an improved electrical connector for solving above problems.

### SUMMARY

In one aspect, the present invention includes an electrical connector. The electrical connector comprises an insulative housing having a body portion and a mating portion forwardly extending from the body portion; a plurality of contacts comprising a plurality of ground contacts and a plurality pairs of differential signal contacts located between the ground contacts, each contact having a retaining portion retained in the insulative housing, a contact portion extending to the mating portion from one end of the retaining portion, and a tail portion extending to a rear side of the body portion from another end of the retaining portion; and a circuit board arranged at a rear side of the body portion, and having a plurality of ground connections and a conductive path connecting the ground connections together, the ground connections connecting with the tail portions of the ground contacts.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

The components in the drawing are not necessarily drawn to scale, the emphasis instead being placed upon clearly illustrating the principles of the described embodiments. In the drawings, reference numerals designate corresponding parts throughout various views, and all the views are schematic.

FIG. 1 is a perspective view illustrating a first embodiment of an electrical connector in the present disclosure;

FIG. 2 is a perspective view of the electrical connector without a rear cover thereof shown in FIG. 1

FIG. 3 is an exploded view of the electrical connector shown in FIG. 1;

FIG. 4 is a view similar to FIG. 3, while viewed from another aspect;

FIG. 5 is a perspective view of the contacts, ground member and circuit board of the electrical connector shown in FIG. 1;

FIG. 6 is a view similar to FIG. 6, while viewed from another aspect;

FIG. 7 is an exploded view of the contacts, ground member and circuit board shown in FIG. 5;

FIG. 8 is an exploded view of the contacts, ground member and circuit board shown in FIG. 6;

FIG. 9 is a perspective view illustrating a second embodiment of an electrical connector without a rear cover thereof in the present disclosure;

FIG. 10 is a perspective view of the contacts, ground member and circuit board of the electrical connector shown in FIG. 9;

FIG. 11 is an exploded view of the contacts, ground member and circuit board shown in FIG. 10;

FIG. 12 is a view similar to FIG. 11, while viewed from another aspect.

### DETAILED DESCRIPTION OF THE ILLUSTRATED EMBODIMENT

Reference will now be made to the drawing figures to describe the embodiments of the present disclosure in detail. In the following description, the same drawing reference numerals are used for the same elements in different drawings.

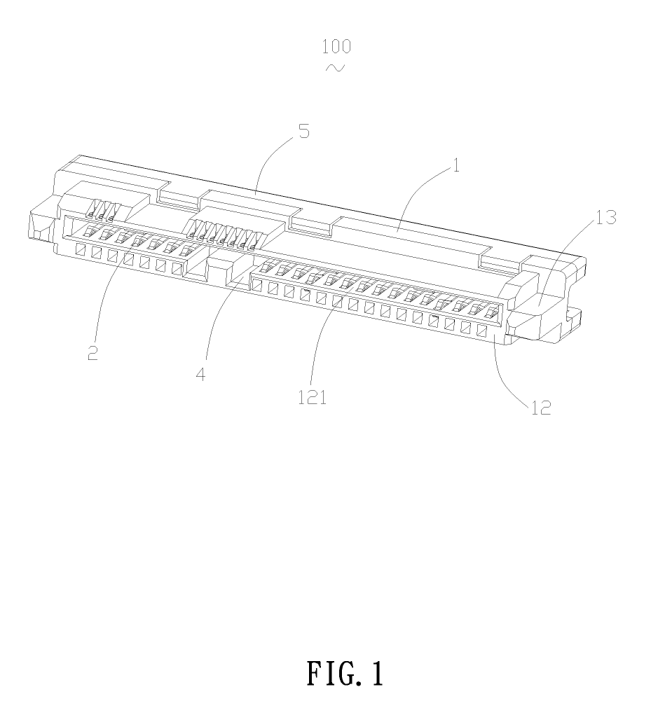

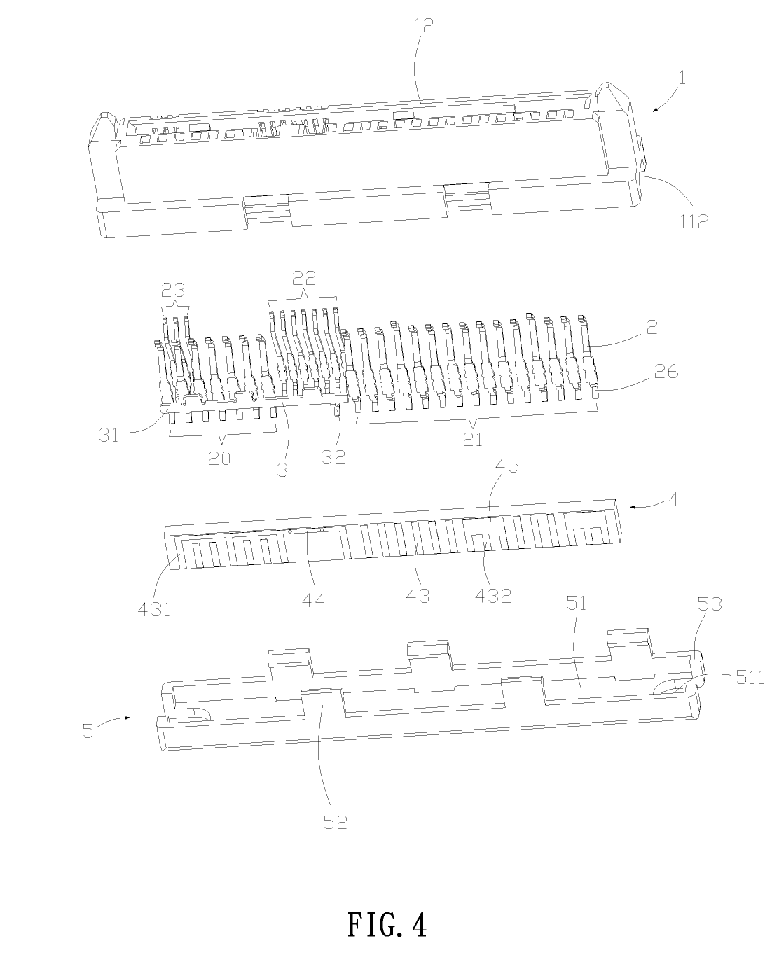

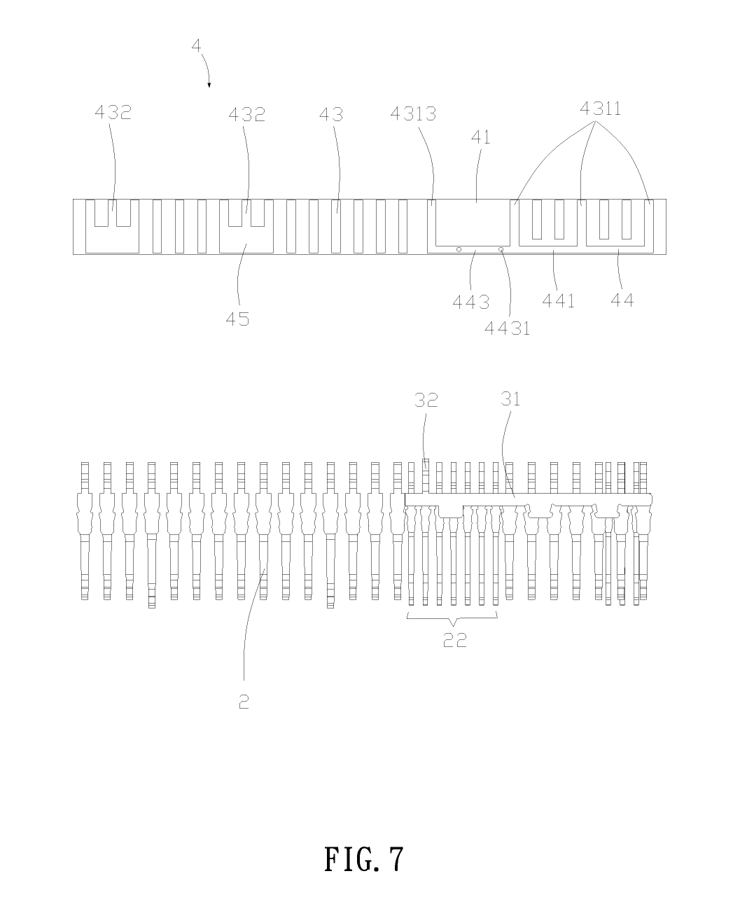

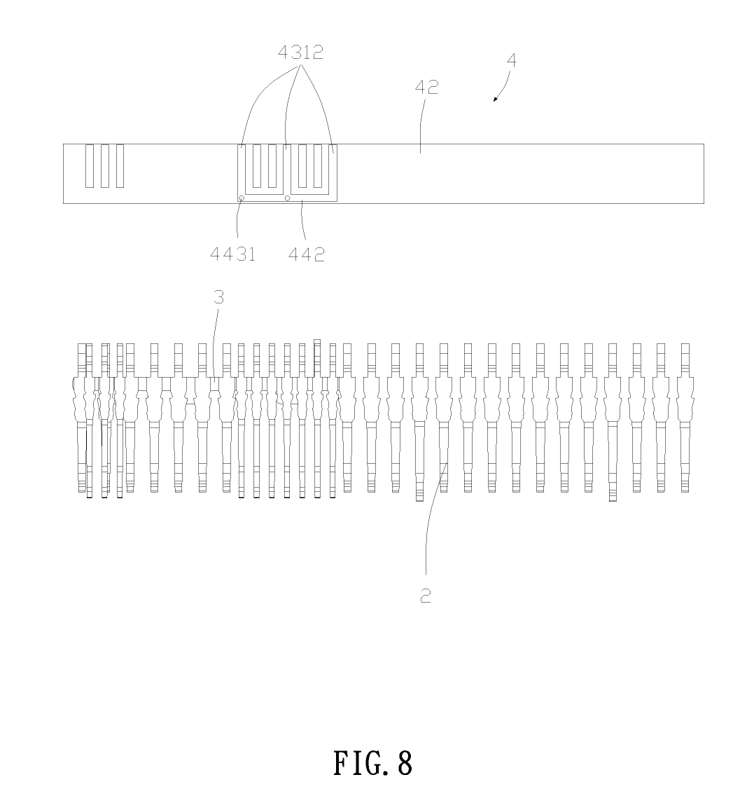

Referring to FIGS. 1 to 8, a first illustrated embodiment of the present disclosure discloses an electrical connector 100. The electrical connector 100 is a cable end SATA connector, and comprises an insulative housing 1, a plurality of contacts 2 and a ground member 3 retained in the insulative housing 1, a circuit board 4 located at a rear side of the insultive housing 1, and a rear cover 5 covering the rear side of the insulative housing 1.

Referring to FIGS. 1 to 4, the insulative housing 1 is longitudinal and has a body portion 11, a mating portion 12 forwardly extending from the body portion 11, a pair of guide posts 13 forwardly extending from two lateral sides of a front end of the body portion 11. The guide posts 13 connect with two lateral sides of the mating portion 12 along a longitudinal direction of the insulative housing 1.

The body portion 11 defines a receiving portion 110 at a rear side thereof, a plurality of locking recesses 111 at upper and lower sides thereof, and two cutouts 112 at two lateral sides thereof. The cutouts 112 communicate with the receiving portion 110 for letting the cable connecting with the contacts 2 through there. The rear cover 5 is provided with a cover portion 51 covering the rear side of the receiving portion 110, a plurality of latches 52 forwardly extending from the cover portion 51 and two side portions 53 extending from two lateral sides of the cover portion 51. The latches 52 lock with the locking recesses 111 to retain the rear cover 5 to the insulative housing 1. The cover portion 51 defines two openings 511 extending therethrough along a front to back direction. The openings 511 are located at two sides of the cover portion 51 and adjacent to the side portions 53. The openings 511 communicate with the cutouts 112 for letting the cable connecting with the contacts 2 through there.

The mating portion 12 defines a longitudinal uninterrupted slot 121 and two parallel first and second sidewalls 122, 123 at two sides of the slot 121. The slot 121 opens forwardly and is used to receive a mating connector (not shown). The second sidewall 123 is divided at an inside surface thereof, to two separated first and second parts 1232, 1233 by a groove 1231 without any contacts and extending through the front face in a back to front direction. The first sidewall 122 is provided with a first expanding portion 1221 aligned with the groove 1231 and a second expanding portion 1222 aligned with the second part 1233 along a thickness direction of the insulative housing 1. The first and second expanding portions 1221, 1222 are heightened outwardly in the thickness direction of the insulative housing 1.

The insulative housing 1 defines a plurality of passageways 14 extending along the front to back direction for receiving the contacts 2, wherein the first part 1232 and the first expanding portion 1221 are arranged with seven passageways 14 respectively, the second part 1233 is arranged with fifteen passageways 14, and the second expanding portion 1222 is arranged with three passageways 14. The passageways 14 on the first and second expanding portions 1221, 1222 extend through the insulative housing 1 forwardly and upwardly. Besides, the insulative housing 1 further defines a receiving groove 15 for retaining the ground member 3. The receiving groove 15 is located behind the first part 1232, and located at outside of the passageways 14 along the thickness direction of the insulative housing 1.

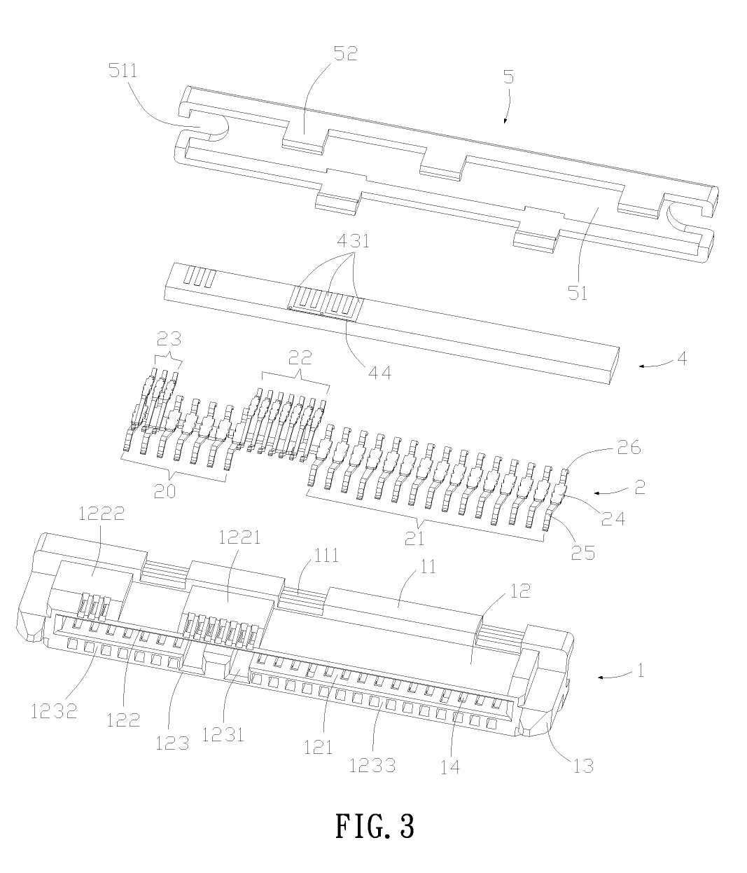

Referring to FIGS. 3 to 8, the contacts 2 comprise a plurality pairs of differential signal contacts, a plurality of ground contacts and a plurality of power contacts. The contacts 2 are grouped into four groups comprising first, second, third and fourth contact groups 20˜23 which are arranged on the first part 1232, the second part 1233, the first expanding portion 1221 and the second expanding portion 1222 respectively. Each contact 2 has a retaining portion 24 retained in the passageways 14 of the body portion 11, a contact portion 25 extending to the mating portion 12 from one end of the retaining portion 24, and a tail portion 26 extending to a rear side of the body portion 11 from another end of the retaining portion 24. The contact portions 25 protrude into the slot 121 for electrically connecting with the mating connector. The tail portions 26 are received in the receiving portion 110. In the present embodiment, the tail portions 26 present as V-shaped for being surface mounted to the circuit board 4.

The differential contacts are arranged in the first and third contact groups 20, 22. Each of the first and third contact groups 20, 22 has seven contacts 2 which are retained in the passageways 14 of the first part 1232 and the first expanding portion 1221. The seven contacts 2 in the first contact group 20 are functioned as a signal-segment S1˜S7 defined in SATA Specification, and comprise three ground contacts and two pairs of differential signal contacts between the ground contacts. The seven contacts 2 in the third contact group 22 are functioned as a signal-segment S8˜S14 defined in SATA Specification, and also comprise three ground contacts and two pairs of differential signal contacts between the ground contacts. The second contact group 21 comprises fifteen contacts 2 which are retained in the passageways 14 of the second part 1233. The contacts 2 in the second contact group 21 are functioned as a signal-segment P1˜P15 defined in SATA Specification, and comprise six power contacts which are P7˜P9 and P13˜P15. The fourth contact group 23 has three contacts which are retained in the passageways 14 of the second expanding portion 1222. The contacts 2 in the fourth contact group 23 are functioned as a signal-segment E7˜E9 defined in SATA Specification.

Besides, the arrangement of contacts 2 in the present invention is consistent to that in the SATA Specification, that is the contacts in the first and second contact groups 20, 21 are arranged in a row at upper side of the slot 121, and the contacts 2 in the third and fourth contact groups 22, 23 are arranged in another row at lower side of the slot 121.

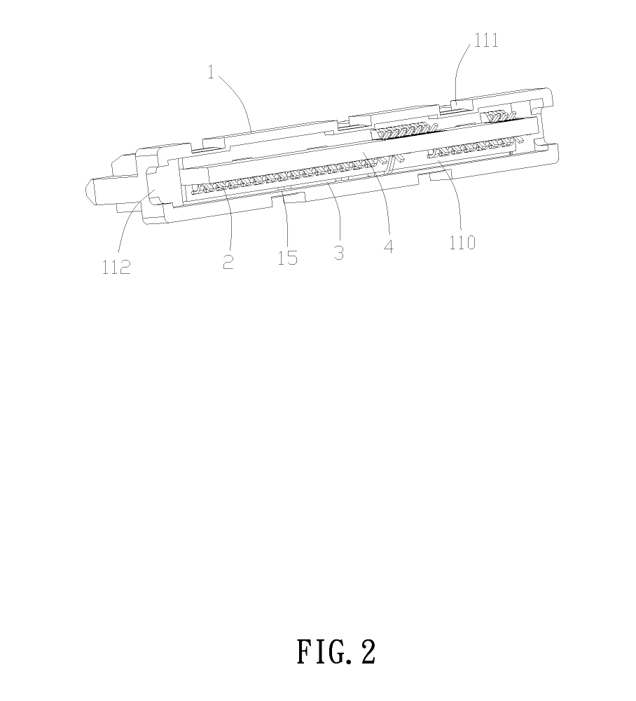

Referring to FIGS. 2, 4 and 5, the ground member 3 has a base 31 retained in the receiving groove 15 and a leg 32 extending from the base 31. As described above, the differential signal contacts are arranged in rows along the longitudinal direction, the base 31 extends along a longitudinal direction of the insulative housing 1, and the length of the base 31 is not less than the total length of the rows of the differential signal contacts along the longitudinal direction. Therefore, the ground member 3 can shield the differential signal contacts from EMI and ensure high frequency signal transmission stably. The leg 32 is located between the tail portions 26 of the first contact group 20 and the second contact group 21.

Referring to FIGS. 2 to 6, in the first embodiment, the circuit board 4 is set parallel to the first and second sidewalls 122, 123 for surface mounting the tail portions 26 thereon. In detail, the circuit board 4 is sandwiched between the tail portions 26 of the first, second contact groups 20, 21, and the third, fourth contact groups 22, 23, and has a first conductive layer 41 connecting with the first and second contact groups 20, 21, and a second conductive layer 42 connecting with the third and fourth contact groups 22, 23. The first and second layers 41, 42 are provided with a plurality of connections 43 for connecting with the tail portions 26 of the contacts 2. The connections 43 in the first embodiment are golden fingers arranged on outer surface of the first and second layers 41, 42.

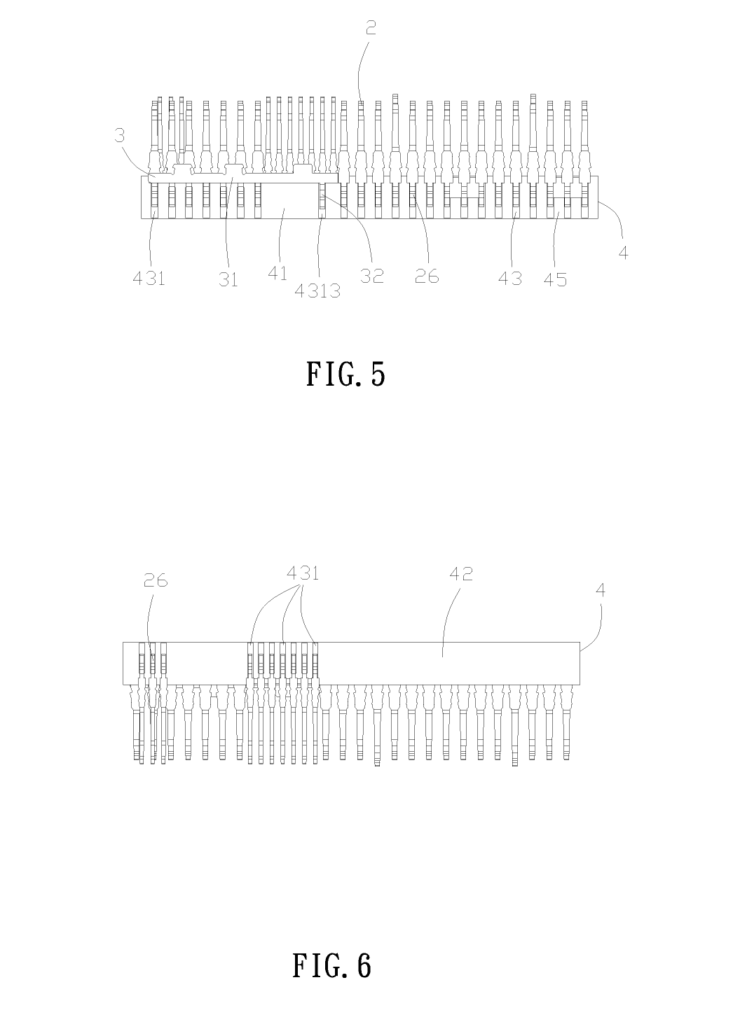

Referring to FIGS. 5 to 8, the connections 43 comprise a plurality of ground connections 431. The ground connections 431 comprise a plurality of first connections 4311 connecting with the ground contacts in the first contact group 20, and a plurality of second connections 4312 connecting with the ground contacts in the third contact group 22. Besides, the circuit board 4 further has a conductive path 44 connecting the ground connections 431 together. Then, when the electrical connector 100 is connected with the cable, the ground wires in the cable for connecting with the ground contacts can be decrease to only one, and the only one ground wire can be connect with any position of the conductive path 44. Therefore, the density of the wires would be decreased, which is convenient for soldering and avoid short circuited, and the cable will be led out from the openings 511 easily.

In the present embodiment, the conductive path 44 comprises a first path 441 provided in the first conductive layer 41 to connect with the first connections 4311, a second path 442 provided in the second conductive layer 42 to connect with the second connections 4312, and a third path 443 provided in the first or second connection 4311, 4312 to connect the first and second paths 441, 442 together. The third path 443 has a conductive hole 4431 through the circuit board 4 to connect the first or second path 441, 442.

The first path 441 and the second path 442 connect with the same end of the first and second connections 4311, 4312 for arranging the wires conveniently. Besides, the connections 43 further comprise a third connection 4313 connecting with the leg 32 of the ground member 3. The third connection 4313 connects with the third path 443. Moreover, because the ground member 3 is located at outside of the first contact ground 20, the leg 32 and the tail portions 26 in the first contact group 20 are arranged in a row. Then the third connection 4313 are provided in the first conductive layer 41, and the third path 443 is arranged in the first conductive layer 41 and connect between the first conductive path 441 and the third connection 4313. The conductive hole 4431 extends through the circuit board 4 and connects the third path 443 and the second path 442.

Of course, in another alternative embodiment, the ground member 3 can be set behind the first expanding portion 1221, and the leg 32 is arranged in the row of the tail portions 26 of the contacts 2 in the third contact group 22. Then the third connection 4313 and the third path 443 are provided in the second conductive layer 42. The conductive hole 4431 extends through the circuit board 4 and connects the third path 443 and the first path 441.

The connections 43 further comprise a plurality of power connections 432 for connecting with the tail portions 26 of the power contacts. The circuit board 4 further has two connection paths 45. Each connection path 45 connects adjacent three power connections 432 together, which can increase the power transmission and decrease the wires for connecting with the power contacts. Of course, two connection paths 45 can be connected together.

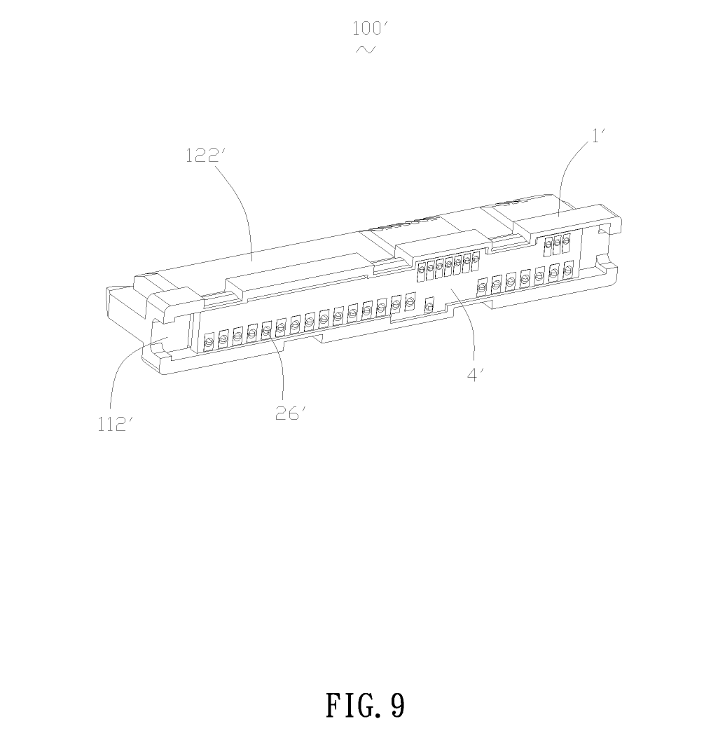

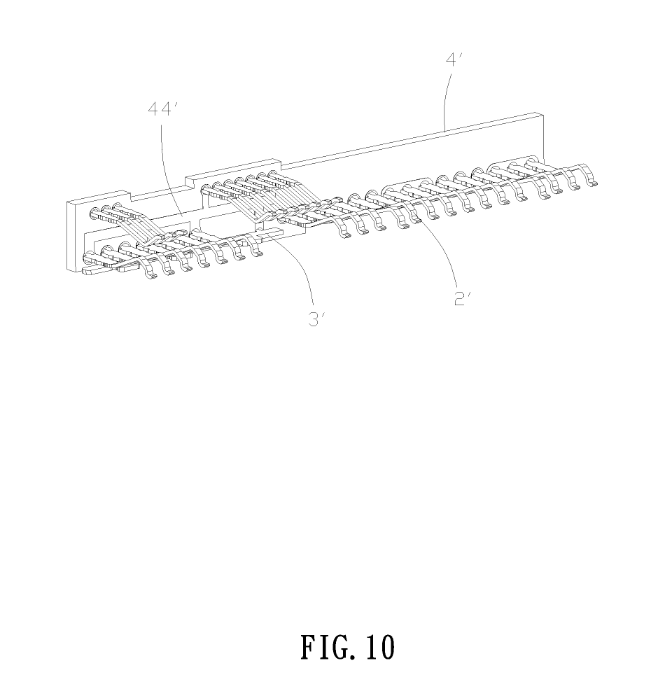

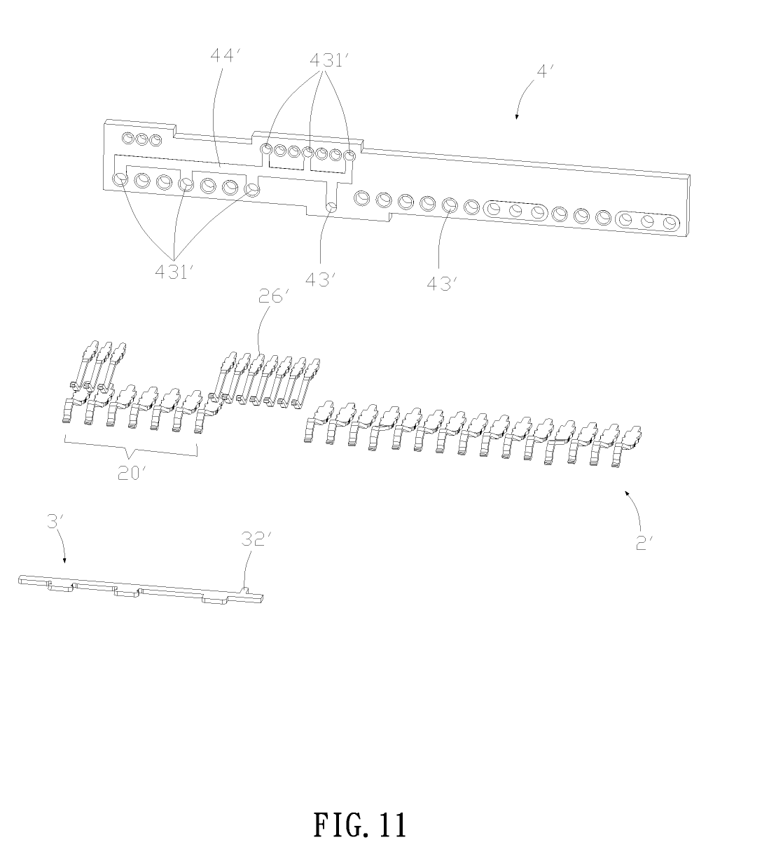

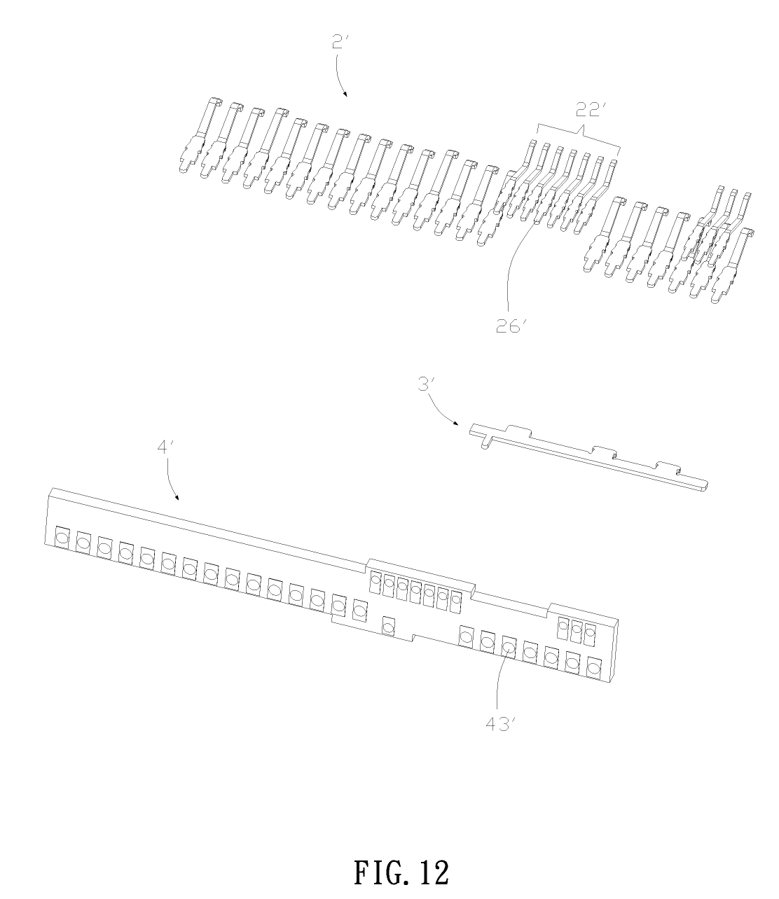

Referring to FIGS. 9 to 12, in accordance with a second preferred embodiment of the present invention, an electrical connector 100′ is similar to that in the first embodiment except the tail portions 26′ of the contacts 2′, the leg 32′ of the ground member 3′ and the circuit board 4′.

In the second embodiment, the tail portions 26′ and the leg 32′ of the ground member 3′ are vertical to the circuit board 4′ and mounted to the circuit board 4′ by insert welding. Therefore, the connections 43′ of the circuit board 4′ in the second embodiment are through holes extending through the circuit board 4′.

In detail, referring to FIGS. 9 to 12, the circuit board 4′ is perpendicular to the first sidewall 122′. The ground connections 431′ are ground through holes, and the tail portions 26′ of the ground contacts are inserted and soldered in the ground through holes. Besides, the tail portions 26′ of the ground contacts in the first and third contact groups 20′, 23′ are arranged in two parallel rows, the ground through holes 431′ are arranged in two rows corresponding to the tail portions 26′. The conductive path 44′ is provided between two rows of ground through holes 431′, and connects with the leg 32′ of the ground member 3′ by the through hole 43′.

In summary, as the circuit board 4, 4′ with the conductive path 44, 44′ is added behind the insulative housing 1, 1′, the ground wires for connecting the grounding contacts in the first and third contact groups 20, 20′, 22, 22′ can be decreased to only one, and the only one ground wire can be connect with any position of the conductive path 44, 44′. Therefore, the density of the wires would be decreased, which is convenient for soldering and avoid short circuited, and the cable will be led out from the cutouts 112, 112′ easily.

It is to be understood, however, that even though numerous characteristics and advantages of preferred and exemplary embodiments have been set out in the foregoing description, together with details of the structures and functions of the embodiments, the disclosure is illustrative only; and that changes may be made in detail within the principles of present disclosure to the full extent indicated by the broadest general meaning of the terms in which the appended claims are expressed.

What is claimed is:

1. An electrical connector, comprising:
an insulative housing having a body portion and a mating portion forwardly extending from the body portion;
a plurality of contacts comprising a plurality of ground contacts and a plurality pairs of differential signal contacts located between the ground contacts, each contact having a retaining portion retained in the insulative housing, a contact portion extending to the mating portion from one end of the retaining portion, and a tail portion extending to a rear side of the body portion from another end of the retaining portion; and
a circuit board arranged at a rear side of the body portion, and having a plurality of ground connections and a conductive path connecting the ground connections together, the ground connections connecting with the tail portions of the ground contacts.

2. The electrical connector as claimed in claim 1, wherein the mating portion defines a longitudinal uninterrupted slot and two parallel first and second sidewalls at two sides of the slot, the second sidewall is divided at an inside surface thereof, to two separated first and second parts by a groove, the first sidewall is provided with a first expanding portion aligned with the groove, the contacts are grouped into at least first, second and third contact groups which are arranged on the first part, the second part and the expanding portion, the ground contacts and the differential contacts are arranged in the first and third contact groups.

3. The electrical connector as claimed in claim 2, wherein the circuit board is parallel to the first sidewall, the ground connections are golden fingers arranged on outer surface of the circuit board, and comprise a plurality of first connections connecting with the ground contacts in the first contact group and a plurality of second connections connecting with the ground contacts in the third contact group.

4. The electrical connector as claimed in claim 3, wherein the circuit board is sandwiched between the tail portions of the contacts in first and third contact groups, and has a first conductive layer connecting with the first contact group and a second conductive layer connecting with the third contact group, the conductive path comprises a first path provided in the first conductive layer to connect with the first connections, a second path provided in the second conductive layer to connect with the second connections, and a third path provided in the first or second connection to connect with the first and second paths, the third path has a conductive hole through the circuit board.

5. The electrical connector as claimed in claim 2, wherein the circuit board is perpendicular to the first sidewall, the ground connections are a plurality of through holes, and the tail portions of the ground contacts are inserted and soldered in the through holes.

6. The electrical connector as claimed in claim 5, wherein the tail portions of the ground contacts in the first and third contact groups are arranged in two parallel rows, the through holes are arranged in two rows corresponding to the tail portions, and the conductive path are provided between two rows of the through holes.

7. The electrical connector as claimed in claim 1, further comprising a grounding member, wherein the ground member has a base secured in the body portion and a leg extending from the base, the circuit board is provided with another connection to connect with the leg, said another connection connects with the conductive path.

8. The electrical connector as claimed in claim 7, wherein the differential signal contacts are arranged in rows along a longitudinal direction, the base of the ground member extends along a longitudinal direction of the insulative housing, and the length of the ground member is not less than the total length of the rows of the differential signal contacts along the longitudinal direction.

9. The electrical connector as claimed in claim 7, wherein the mating portion defines a longitudinal uninterrupted slot and two parallel first and second sidewalls at two sides of the slot, the second sidewall is divided at an inside surface thereof, to two separated first and second parts by a groove, the first sidewall is provided with a first expanding portion aligned with the groove, the contacts are grouped into at least first, second and third contact groups which are arranged on the first part, the second part and the expanding portions, the ground contacts and the differential contacts are arranged in the first and third contact groups, the base of the ground member is parallel to and located at outside of the retaining portions of the contacts in the first contact group, the leg is located between the first contact group and the second contact group.

10. The electrical connector as claimed in claim 1, wherein the second contact group comprises a plurality of power contacts, the circuit board further has a plurality of power connections and at least a connection path connecting at least part of the power connections together.
